(19) United States
(12) Patent Application Publication
(10) Pub. No.: US 2025/0316158 A1
(43) Pub. Date: Oct. 9, 2025

(54) SYSTEM AND METHOD FOR MONITORING A DWELLING

(71) Applicant: MWC FAMILY LP, East Hampton, NY (US)

(72) Inventor: Michael Crow, East Hampton, NY (US)

(21) Appl. No.: 19/098,726

(22) Filed: Apr. 2, 2025

Related U.S. Application Data
(60) Provisional application No. 63/574,363, filed on Apr. 4, 2024.

(51) Int. Cl. G08B 26/00; G06Q 30/0207; G08B 29/02

(52) U.S. Cl. CPC G08B 26/008; G06Q 30/0224; G08B 29/02

(57) ABSTRACT

Provided herein is a system for monitoring dwellings. The system includes a server; a plurality of sensors located at one or more dwellings, the plurality of sensors configured to generate sensor data and communicate the sensor data to the server; and monitoring software configured to run on the server. The monitoring software is configured to process the sensor data and generate at least one user interface. Additionally, the at least one user interface is accessible through a remote compute device and is configured to display at least one of the sensor data and one or more alerts. Also provided are a method of monitoring a multi-unit dwelling using the system and a non-transitory, processor-readable medium storing instructions for executing the method.

### CROSS-REFERENCE TO RELATED APPLICATIONS

The present application claims priority under 35 U.S.C. §119(e) to U.S. Provisional Patent Application No. 63/574,363, filed Apr. 4, 2024, which application is incorporated herein by reference in its entirety.

### FIELD OF THE INVENTION

The present invention relates to a system and method for monitoring a residential home or multi-family dwelling, and in particular to a system and method using multiple connected sensor devices to monitor hazardous conditions within the dwelling, provide rapid response to any such conditions, and utilize collected data to predict and prepare for losses before they occur.

### BACKGROUND OF THE INVENTION

Damage caused by fire and water account for the bulk of all property damage in multi-unit dwellings (i.e., apartment buildings) and majority of residential properties. In terms of insurance, fire accounts for over ninety percent (90%) of the significant losses incurred by insurance companies in multifamily residential buildings. Specifically, nonconfined fires cause virtually all significant insurance losses in multifamily residential buildings. Fires in multifamily residential buildings are caused primarily by cooking accidents. The average response time of the local Fire Department to a fire in a multifamily residential building is seven (7) minutes. The large measure of multifamily residential buildings are over thirty (30) years old, and do not have active fire monitoring systems. The only protection against fire in these types of buildings are battery-operated smoke alarms which are not connected to any type of computer network. National studies show that these types of batter-operated smoke alarms are in place and operational less than 40% of the time. None of these types devices are monitored, or connected to any computer system or network, and rely solely on an audible signal to alert residents of a fire. Smoke alarms are most often located in a tenant dwelling, and not in common areas monitored by building management (i.e., hallways, maintenance shops, boiler rooms, lobby, etc.). If a tenant is not keeping up with smoke alarm battery maintenance, or worse yet, has intentionally disabled smoke alarms in their unit, the entire multifamily residential building and lives, are placed at risk.

Accordingly, there remains a need in the art for improved systems and methods for monitoring dwellings. The present invention meets this need.

### SUMMARY

In one aspect, system includes a server; a plurality of sensors located at one or more dwellings, the plurality of sensors configured to generate sensor data and communicate the sensor data to the server; and monitoring software configured to run on the server; where the monitoring software is configured to process the sensor data and generate at least one user interface, the at least one user interface is accessible through a remote compute device, and the at least one user interface is configured to display at least one of the sensor data and one or more alerts.

In some embodiments, the system further includes a machine-learning model configured to run on the server, wherein the machine-learning model is configured to automatically generate the one or more alerts based upon the sensor data. In some embodiments, the machine-learning model is an unsupervised machine-learning model, a supervised machine-learning model, a deep learning model, or a convolutional neural network (CNN). In some embodiments, the machine-learning model generates the one or more alerts in response to the sensor data deviating from a set of threshold values. In some embodiments, the machine-learning model is configured to automatically adjust the set of threshold values. In some embodiments, the system further comprises a database and the server is further configured to store the sensor data and the set of predetermined threshold values in the database. In some embodiments, the set of threshold values includes a set of combination threshold values, the set of combination threshold values being determined from threshold values for two or more individual sensor types from the plurality of sensors.

In some embodiments, the one or more alerts include a security alert, a fire alert, a mold alert, an occupancy alert, a carbon monoxide alert, a water leak alert, an electrical alert, a sensor status alert, or a combination thereof. In some embodiments, the plurality of sensors includes at least one of a water flow sensor, a water leak sensor, a temperature sensor, a motion sensor, a license plate recognition sensor, a smoke detector, a carbon monoxide sensor, a thermal imaging sensor, a barometric sensor, a power line sensor, a current sensor, and combinations thereof. In some embodiments, the plurality of sensors are connected through the internet of things (IoT). In some embodiments, the sensor data comprises multimodal telemetry data.

In some embodiments, the at least one user interface comprises one or more of a property owner interface, a property manager interface, and a tenant interface. In some embodiments, the property owner interface displays the sensor data and the one or more alerts for at least one property owned by a property owner, the at least one property including at least one of the one or more dwellings; the property manager interface displays the sensor data and the one or more alerts for at least one of the one or more dwellings managed by a property manager; and the tenant interface displays the sensor data and the one or more alerts for at least one of the one or more dwellings assigned to a tenant. In some embodiments, the monitoring software provides automatic communication between two or more of the property owner, the property manager, and the tenant. In some embodiments, the system is configured to automatically update the status of the one or more alerts based upon updated sensor data, input from the tenant, input from the property manager, input from the property owner, communication with the authorities, or a combination thereof. In some embodiments, the remote compute device for at least one of the user interfaces comprises a mobile device and at least one of the user interfaces comprises a mobile device application.

In some embodiments, the system is further configured to generate a behavior score for a tenant based upon the sensor data from one or more sensors of the plurality of sensors that are specific to the tenant. In some embodiments, the system is further configured to dynamically allocate a reward for the tenant based on the behavior score.

In another aspect, a method of monitoring a multi-unit dwelling includes providing the system according to any of the embodiments disclosed herein; receiving, at the server, the sensor data from the plurality of sensors; executing the machine-learning model on the sensor data, the machine-learning model generating the one or more alerts; generating the at least one user interface accessible through the remote compute device. In some embodiments, the method further includes automatically sending a signal to at least one of emergency services, a property owner, a property manager, and a tenant for at least one of the one or more alerts.

In some embodiments, the method further includes generating a behavior score for a tenant based upon the sensor data from one or more sensors of the plurality of sensors that are specific to the tenant. In some embodiments, the method further includes dynamically allocating a reward for the tenant based on the behavior score. In some embodiments, the sensors specific to the tenant include the sensors associated with a tenant dwelling assigned to the tenant, the sensor data associated with a vehicle of the tenant, the sensor data relating to location of the tenant, or a combination thereof.

In some embodiments, the method further includes training the machine-learning model, the training including providing a training set including at least one of tenant data, property data, and significant events related thereto; and training the machine-learning model to generate the one or more alerts with the training set. In some embodiments, the training set includes at least one of tenant data and property compared to significant events related thereto.

In another aspect, a non-transitory, processor-readable medium storing instructions that, when executed by a processor, cause the processor to implement the method according to any of the embodiments disclosed herein.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views.

FIG. 1 is a block diagram illustrating a system for monitoring a multi-unit dwelling using artificial intelligence, according to some embodiments.

FIG. 2 is an illustrative representation of a process flow for monitoring a multi-unit dwelling using artificial intelligence, according to some embodiments.

FIGS. 3A-Q are example screenshots of a monitoring dashboard, according to some embodiments.

### DETAILED DESCRIPTION OF THE INVENTION

### Definitions

The instant invention is most clearly understood with reference to the following definitions.

As used herein, the singular form “a,” “an,” and “the” include plural references unless the context clearly dictates otherwise.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used in the specification and claims, the terms “comprises,” “comprising,” “containing,” “having,” and the like can have the meaning ascribed to them in U.S. patent law and can mean “includes,” “including,” and the like.

Unless specifically stated or obvious from context, the term “or,” as used herein, is understood to be inclusive.

The terms “proximal” and “distal” can refer to the position of a portion of a device relative to the remainder of the device or the opposing end as it appears in the drawing. The proximal end can be used to refer to the end manipulated by the user. The distal end can be used to refer to the end of the device that is inserted and advanced and is furthest away from the user. As will be appreciated by those skilled in the art, the use of proximal and distal could change in another context, e.g., the anatomical context in which proximal and distal use the patient as reference, or where the entry point is distal from the user.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

The phrase “based on” does not mean “based only on,” unless expressly specified otherwise. In other words, the phrase “based on” describes both “based only on” and “based at least on.”

The term “processor” should be interpreted broadly to encompass a general-purpose processor, a central processing unit (CPU), a microprocessor, a digital signal processor (DSP), a controller, a microcontroller, a state machine and so forth. Under some circumstances, a “processor” can refer to an application specific integrated circuit (ASIC), a programmable logic device (PLD), a field programmable gate array (FPGA), etc. The term “processor” can refer to a combination of processing devices, e.g., a combination of a DSP and a microprocessor, multiple microprocessors, one or more microprocessors in conjunction with a DSP core or any other such configuration.

The term “memory” should be interpreted broadly to encompass any electronic component capable of storing electronic information. The term memory can refer to various types of processor-readable media such as random-access memory (RAM), read-only memory (ROM), non-volatile random-access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” can refer to one or more programs, routines, sub-routines, functions, procedures, etc. “Instructions” and “code” can comprise a single computer-readable statement or many computer-readable statements.

The term “modules” can be, for example, distinct but interrelated units from which a program can be built up or into which a complex activity can be analyzed. A module can also be an extension to a main program dedicated to a specific function. A module can also be code that is added in as a whole or is designed for easy reusability.

### DETAILED DESCRIPTION

Provided herein are systems for monitoring dwellings, such as, but not limited to, residential dwellings, multi-unit dwellings, and/or multiple properties including one or more dwellings. In some embodiments, the system includes one or more computers or computer systems, a plurality of sensors configured to generate sensor data and communicate the sensor data to the one or more computers or computer systems, and monitoring software configured to run on the one or more computers or computer systems. The one or more computers or computer systems include any computer or computer system capable of receiving the sensor data and running the monitoring software. For example, in some embodiments, the one or more computers or computer systems include a server (e.g., a cloud server or any other suitable server) configured to receive the sensor data and run the monitoring software. The system can also include a database for storing the sensor data.

The plurality of sensors include any suitable sensors for monitoring the dwellings. For example, suitable sensors include, but are not limited to, water flow sensors, water leak sensors, water pulse sensors, temperature sensors, humidity sensors, motion sensors, cameras that detect certain movement and activity, license plate reading/recognition cameras, smoke detectors, carbon monoxide sensors, door open/closed sensors, window open/closed sensors, thermal imaging sensors, barometric sensors, power line sensors, current sensors, and/or combinations thereof. As will be appreciated by those skilled in the art, in addition to the system including multiple different types of sensors, any suitable sensor types may be combined into a single sensor (e.g., combined smoke alarm and CO sensor).

In some embodiments, at least one of the sensors is remote with respect to the one or more computers or computer systems (e.g., server). Accordingly, in some embodiments, the sensor data includes multimodal telemetry data. In some embodiments, the sensors continuously provide sensor data to the system (i.e., 24 hours a day, 7 days a week). The plurality of sensors can be connected to each other and/or the one or more computers or computer systems through any suitable connection mechanism. For example, in some embodiments, the plurality of sensors are connected through the internet of things (IoT). Additionally or alternatively, in some embodiments, the plurality of sensors operate on the long range (LoRa) frequency band and/or through the LoRaWAN® protocol. LoRa uses license-free sub-gigahertz radio frequency bands, such as 902-928 MHz in North America, and enables long-range transmissions with low power consumption. In some embodiments, the plurality of sensors send gathered data (e.g., via LoRa) to a gateway device that is coupled to the one or more computers or computer systems (e.g., a cloud server). Although discussed herein with respect to IoT and/or LoRa communication, as will be appreciated by those skilled in the art, the disclosure is not so limited and includes any other suitable method of communication such as, but not limited to, Bluetooth, ethernet, satellite, or a combination thereof.

Upon communication to the server (or one or more computer or computer systems), the monitoring software processes the sensor data. In some embodiments, the monitoring software is configured to generate one or more alerts such as, but not limited to, security alerts, fire alerts, mold alerts, occupancy alerts (e.g., squatting, early vacancy, rent skipping), carbon monoxide alerts, water leak alerts, electrical alerts, sensor status alerts, and/or combinations thereof. In some embodiments, the monitoring software is configured to generate the one or more alerts when the sensor data deviates from a set of threshold values. The threshold values can include individual threshold values relating to a specific sensor and/or combination threshold values based upon individual threshold values from two or more sensor types. For example, the set of threshold values for a mold alert may be based on a combination of threshold values for temperature sensors, humidity sensors, water leak sensors, and/or window open/closed sensors. In some embodiments, the monitoring software also processes additional data when generating the one or more alerts. The term “additional data,” as used herein, refers to any relevant data not directly collected by one or more of the sensors. For example, additional data can include, but is not limited to, residential information, tenant location (e.g., determined from mobile device), local utility alerts (e.g., power outages), weather reports (e.g., real-time weather services), real-time operating data, other real-time data (e.g., live cameras), or any other relevant data not collected directly from one or more of the sensors.

In some embodiments, the threshold values for generating the alerts include predetermined values. Additionally or alternatively, in some embodiments, the threshold values (individual and/or combination values) are dynamic. In such embodiments, the dynamic threshold values are adjusted based upon sensor data and/or additional data. For example, the threshold values for a mold alert may be adjusted based upon environmental data from inside the dwelling (e.g., current and/or historical temperature and/or humidity), environmental data from outside the dwelling (e.g., current, historical, and/or predicted environmental conditions determined through exterior sensors and/or a weather report), prior water leak alerts, and/or any other data relevant to likelihood of mold growth. In another example, the threshold values for a security alert and/or occupancy alert may be adjusted based upon dwelling status (e.g., rented or unrented), motion data, tenant location (e.g., is the tenant's mobile device in the dwelling, is the tenant's vehicle present), history of window/door opening, and/or any other data relevant to security and/or occupancy. In some embodiments, the threshold values are stored in the database.

In some embodiments, the system includes a machine-learning model (also referred to herein as artificial intelligence (“AI”)) configured to run on the one or more computers or computer systems (e.g., the server). The machine-learning model can process the sensor data and/or additional data in real-time (i.e., as it is received) and/or from the database. In some embodiments, the machine-learning model is configured to generate the one or more alerts when the sensor data deviates from the set of threshold values. Additionally or alternatively, in some embodiments, the machine-learning model is configured to set the predetermined and/or dynamic threshold values. For example, in some embodiments, the machine-learning model is configured to run on the server and automatically adjust the set of threshold values and/or generate the one or more alerts. The adjustment of the threshold value and/or generation of the one or more alerts by the machine-learning model can be based upon any suitable sensor data, additional data, other information, and/or combinations thereof.

The machine-learning model includes any suitable machine-learning model, such as, but not limited to, an unsupervised machine-learning model, a supervised machine-learning model, a deep learning model, a large language model (LLM), or a convolutional neural network (CNN). In some embodiments, the machine learning model is trained on a training set including tenant and property data. Suitable tenant and property data includes, but is not limited to, data of actual use for payments, emergencies and work orders, evictions, prior history and credit application, number of moves, type of job, any other relevant information compliant with fair housing laws, and/or combinations thereof. In some embodiments, the machine-learning model independently set and/or adjusts the threshold values for individual tenants based upon the tenants specific data. Accordingly, in some embodiments, the machine-learning model provides dynamic, real-time monitoring specific to one or more individual dwellings/tenants.

In some embodiments, the server and/or monitoring software is configured to generate one or more user interfaces at a remote compute device. For example, in some embodiments, the server and/or monitoring software is configured to generate at least one of a property owner interface, a property manager interface, and/or a tenant interface. As will be understood by those skilled in the art, each user interface can have unique login credentials such that only authorized individuals can access each interface. For example, in some embodiments, only a property owner can access the property owner interface, only a property manager can access the property manager interface, and only a tenant can access their individual tenant interface. Alternatively, in some embodiments, certain individuals can access multiple interfaces (e.g., a property owner can access the property owner interface and the property manager interface). Accordingly, the remote compute device may be the same compute device for one or more interfaces, or may be a separate compute device for each interface (e.g., a first compute device for the property owner interface, a second compute device for the property manager interface, and a third compute device for the tenant interface). In some embodiments, at least one of the interfaces is accessible through a mobile device (e.g., the tenant interface includes a mobile application).

Each of the user interfaces displays (or otherwise provides access to) the sensor data and/or the one or more alerts for the relevant dwellings based upon the type of user. In some embodiments, the sensor data and/or the one or more alerts is/are displayed in a monitoring dashboard. In such embodiments, the monitoring dashboard can be tailored for each type of user. For example, in some embodiments, the property owner interface displays a monitoring dashboard including the sensor data and/or the one or more alerts for dwellings owned by a property owner (e.g., all dwellings in a single property, dwellings in multiple properties). In some embodiments, the property manager interface displays a monitoring dashboard including the sensor data and/or the one or more alerts for dwellings managed by a property manager (e.g., a specific set of dwellings within a property, all of the dwellings within a property, dwellings in multiple properties). In some embodiments, the tenant interface displays a monitoring dashboard including the sensor data and/or the one or more alerts specific to the dwelling(s) leased/rented by a tenant.

In some embodiments, the one or more alerts are displayed on the monitoring dashboard for each user (e.g., property owner, property manager, tenant) associated with the dwelling for the which alert(s) are generated. Alternatively, in some embodiments, one or more alerts are only displayed on the monitoring dashboard for certain users. For example, in such embodiments, alerts needing immediate attention (e.g., fire, flood, etc.) may be displayed to all users associated with the dwelling, while other alerts (e.g., device offline, early vacancy, etc.) are only displayed to certain users (e.g., property owner and/or property manager). In some embodiments, alerts needing immediate attention are automatically pushed to one or more users (e.g., notification on a mobile device). Additionally or alternatively, in some embodiments, one or more alerts (e.g., fire, flood, break-in, etc.) are automatically sent to emergency services (e.g., live call to local police, fire department, or other emergency services).

In some embodiments, the system and/or monitoring software enables action based upon the sensor data and/or alerts. For example, in some embodiments, the monitoring dashboards include options for taking action on one or more alerts. In such embodiments, the options may be different for each user. In one embodiment, for example, the property owner interface enables a property owner to send instructions for addressing an alert directly to a property manager. In another embodiment, the property manager interface enables a property manager to acknowledge instructions, update status, indicate when an alert has been cleared, and/or note when further action is required. In a further embodiment, the tenant interface enables a tenant to confirm, explain, or deny an alert. Additionally or alternatively, the property owner interface and/or property manager interface can enable communication of instructions to other relevant parties, such as tenants and/or maintenance workers. In some embodiments, the monitoring software tracks and automatically updates the status of each alert for each user.

The monitoring software can also be configured to enable manual or automatic communication between users. The communication can be through the user interfaces, push notifications on mobile devices, automated or manual text messages, and/or automated or manual phone calls. Additionally, the communication can be between any one or more users and/or between any user and emergency services. In some embodiments, the alerts and/or status updates are communicated differently based upon alert type and/or action taken. For example, in some embodiments, the monitoring software is configured to automatically communicate urgent alerts and/or status updates to all associated users (e.g., property owner, property manager, individual tenants, multiple tenants, all tenants) and/or emergency services through automated phone calls, text messages, and/or push notifications. Additionally or alternatively, in some embodiments, the monitoring software is configured to automatically communicate non-urgent alerts and/or status updates to specific users based upon the alert/update type (e.g., notes/comments only sent to property owners/property managers/maintenance, alert resolution sent to all users directly associated with the alert). Any of the alerts/updates disclosed herein can also be manually initiated in the user interfaces and sent to appropriate users and/or emergency services.

Although disclosed herein primarily with respect to a property owner interface, property manager interface, and tenant interface, as will be appreciated by those skilled in the art, the disclosure is not so limited and may include any other suitable arrangement or type of user interface. For example, in some embodiments, the monitoring software is configured to generate a maintenance interface. In some such embodiments, the maintenance interface only displays sensor data and/or alerts for dwellings assigned to a specific maintenance worker. Alternatively, in some embodiments, the monitoring software does not generate a separate maintenance interface, but instead sends notifications directly to selected maintenance workers through text message. In some such embodiments, the maintenance workers can respond to the text message and the monitoring software and/or machine-learning model can automatically update the alert status based upon the text response.

In some embodiments, the system is further configured to generate a behavior score for a tenant. In some embodiments, a behavior score is generated for each tenant that rents, leases, or otherwise owns a monitored dwelling. In some embodiments, the behavior score is based upon the sensor data from one or more sensors of the plurality of sensors that are specific to the tenant. For example, sensors specific to the tenant may include, but are not limited to, sensors related to water usage, temperature control, opening and closing of doors/windows, motion, and/or combinations thereof. In some embodiments, the system is configured to dynamically allocate a reward for the tenant based on the behavior score. The reward may include any suitable reward, such as, but not limited to, a discount on rent. In some embodiments, the behavior score and/or the reward are displayed on the tenant interface.

Also provided herein are methods of monitoring a multi-unit dwelling. In some embodiments, the method includes providing the system according to any of the embodiments disclosed herein and receiving, at the server, the sensor data from the plurality of sensors. After receiving the sensor data at the server, the method includes inputting the sensor data to the monitoring software. The monitoring software then generates one or more alerts based upon the sensor data, as described in any of the embodiments disclosed herein.

In some embodiments, the method further includes generating one or more user interfaces accessible through a remote compute device, each user interface configured to display or provide access to the sensor data and/or the one or more alerts specific to the user. For example, in some embodiments, the method includes generating a property owner interface configured to display the one or more alerts for each of the one or more dwellings at one or more properties owned by a property owner; generating a property manager interface configured to display the one or more alerts for each of the one or more dwellings at one or more of the properties managed by a property manager; and/or generating a tenant interface configured to display the one or more alerts specific to a tenant accessing the tenant interface . . .

Each of the user interfaces is accessible through any suitable remote compute device, such as, but not limited to, a personal computer, tablet, mobile device, and/or any other suitable compute device. The remote compute device may be the same or different for each user interface, with the different user interfaces being accessible through different applications and/or user credentials. For example, in one embodiment, each of the property owner interface, the property manager interface, and the tenant interface can be accessed through the same remote compute device using different applications and/or different user credentials. In another embodiment, the property owner interface is accessible through a first remote compute device, the property manager interface is accessible through a second remote compute device, and the tenant interface is accessible through a third remote compute device.

In some embodiments, the method includes executing a machine-learning model according to any of the embodiments disclosed herein on the sensor data. In such embodiments, the sensor data can be input to the machine-learning model in addition to or in place of the input to the monitoring software. For example, in some embodiments, the machine-learning model is configured to generate the one or more alerts when the sensor data deviates from the set of threshold values. The alerts can then be displayed in the user interfaces by the monitoring software and/or automatically communicated by the monitoring software or the machine-learning model. Additionally or alternatively, in some embodiments, the machine-learning model is configured to set the predetermined and/or dynamic threshold values according to any of the embodiments disclosed herein.

In some embodiments, the method further includes training the machine-learning model. The training includes providing a training set and training the machine-learning model to generate the one or more alerts with the training set. In some embodiments, the training set includes one or more of tenant data, property data, and significant events related thereto. Suitable tenant data, property data, and significant events related thereto includes, but is not limited to, payments, prior history, credit applications, number of moves, type of job, evictions, skips, rent rolls, reports, work orders, fires, floods, other emergencies, any other relevant information compliant with fair housing laws, and/or combinations thereof. In some embodiments, the training includes comparing tenant and/or property data to significant events. For example, in some embodiments, the training includes providing rent rolls and reports and comparing them to results of evictions, skips, and moves. Additionally or alternatively, in some embodiments, the training includes comparing prior tenant data to actual fires and emergencies. In some embodiments, the machine-learning model is able to detect correlations in unrelated data between the tenant and property operations.

The method can also include generating a behavior score for a tenant based upon the sensor data from one or more sensors specific to the tenant. Sensors specific to the tenant include, but are not limited to, sensors associated with a tenant dwelling assigned to the tenant, sensor data associated with a vehicle of the tenant, sensor data relating to location of the tenant, or a combination thereof. In some embodiments, the method further includes dynamically allocating a reward for the tenant based on the behavior score.

In some embodiments, the method includes taking action on and/or tracking the status of an alert. For example, in some embodiments, the property owner interface provides a list of options for addressing each alert. Such options may include, but are not limited to, requesting confirmation of the alert from the tenant, instructing the property manager to investigate/address the alert, contacting emergency services, and/or closing the alert. In some embodiments, the property owner can include a custom note with any option. After selecting an option, the monitoring software automatically contacts the appropriate party and updates the alert status. Once the instructions are received by the relevant party, they are able to update the status of the alert through their respective user interface. For example, in some embodiments, the property manager can indicate that the alert is being investigated, work is being performed, parts have been ordered, and/or note any other suitable update. Additionally or alternatively, the status can automatically be updated based upon new sensor data. Depending upon the alert, each status update entered into the system can be automatically communicated to the other relevant parties. For example, updates regarding sensor status may only need to be communicated to the property manage and not the tenant, whereas updates regarding urgent alerts may need to be communicated to all parties. In some embodiments, the parties notified can be set and/or changed for appropriate parties for each alert type.

In some embodiments, one or more users can generate an alert or other update through the monitoring software. For example, a property manager and/or tenant can generate an alert based upon property inspect. In another example, a tenant can update status to indicate that they will be traveling or otherwise away from the dwelling. In some embodiments, the monitoring software and/or machine-learning model can automatically adjust the threshold values for various alerts based upon user generated alerts and/or updates. For example, the threshold values for motion sensors, window or door opening/closing, temperature fluctuations, and/or other relevant sensors can be adjusted when a tenant generates an update that they will be away from the dwelling. As will be appreciated by those skilled in the art, the disclosure in not limited to the examples above and expressly includes any other suitable alert options and/or communication configurations. For example, in some embodiments, the property manager, rather than the property owner, may take initial action with respect to an alert. In such embodiments, the action taken by the property manager can automatically send a notification to a maintenance worker (e.g., text message, phone call, update to separate maintenance worker user interface, etc.).

Further provided herein is a non-transitory, processor-readable medium storing instructions that, when executed by a processor, cause the processor to implement the method according to any of the methods disclosed herein.

The systems and methods disclosed herein provide continuous, automated monitoring of one or more dwellings. As disclosed herein, the systems and methods can utilize multiple types of sensors in a residential home or group of homes, as well as a multi-family residential property which will often include many separate buildings, and compare sensor data from many IoT devices with other data sources to determine alerts and actions as needed. Through the monitoring software and/or machine-learning model, the systems and methods can predict behaviors and then notify owners and property management of possible and projected issues. Additionally, the systems and methods can automatically notify relevant individuals and/or emergency services of urgent alerts.

Accordingly, in some embodiments, the systems and methods disclosed herein can be used to lower utilities costs (e.g., by providing more rapid response to water leaks), provide advanced warning of potential problems (e.g., when pipes are getting ready to freeze), provide more rapid notification to emergency services, improve remediation time (e.g., through automatic tracking and updating of alerts), and/or provide tenants with actual real-time usage data versus waiting for their monthly bill. The systems and methods may also be used to create proprietary ratings for individual or groups of tenants, which may be used to assess risk for underwriting insurance and related products. In contrast to FICO scores, which rely on financial data only, the ratings disclosed herein are based upon multimodal data streams and can be updated in real time. Furthermore, the systems and methods disclosed herein can increase security, indicate if people are occupying a specified unit at the time of the alarm, and/or alert relevant parties if unauthorized people are inhabiting a unit (e.g., the unit is not rented/leased (i.e., should be vacant) and/or the tenant is travelling/away). This type of data can help to identify squatters at an early stage, so that the local police can be notified and the persons removed before they acquire any legal rights (e.g., typically around 72 hours).

Although the invention has been described in terms of exemplary embodiments, it is not limited thereto. For example, although described herein primarily with respect to monitoring of multi-unit dwellings, as will be appreciated by those skilled in the art, the disclosure is not so limited and may be used to monitor any other suite of internet of things (IoT) connected devices. Accordingly, the appended claims should be construed broadly to include other variants and embodiments of the invention which may be made by those skilled in the art without departing from the scope and range of equivalents of the invention. This disclosure is intended to cover any adaptations or variations of the embodiments discussed herein.

The following examples further illustrate aspects of the present invention. However, they are in no way a limitation of the teachings or disclosure of the present invention as set forth herein.

### EXAMPLES

### Example 1

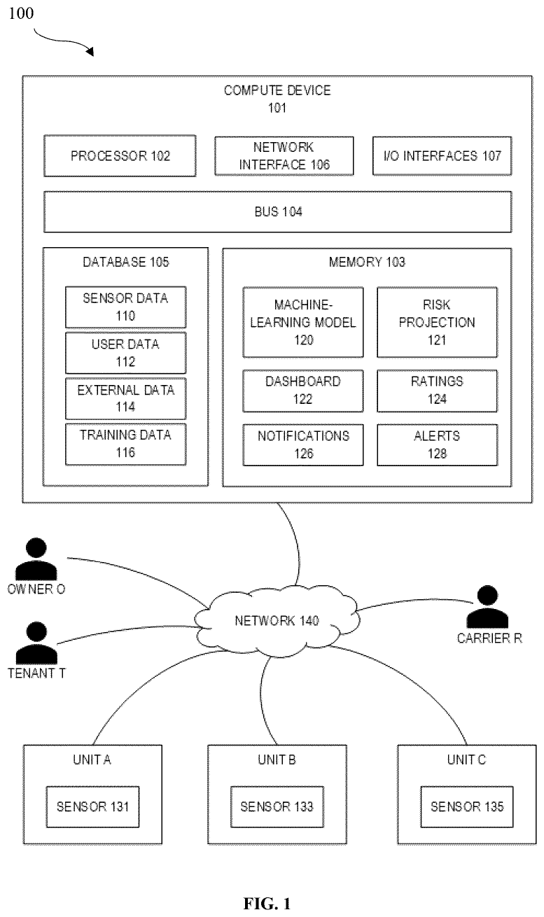

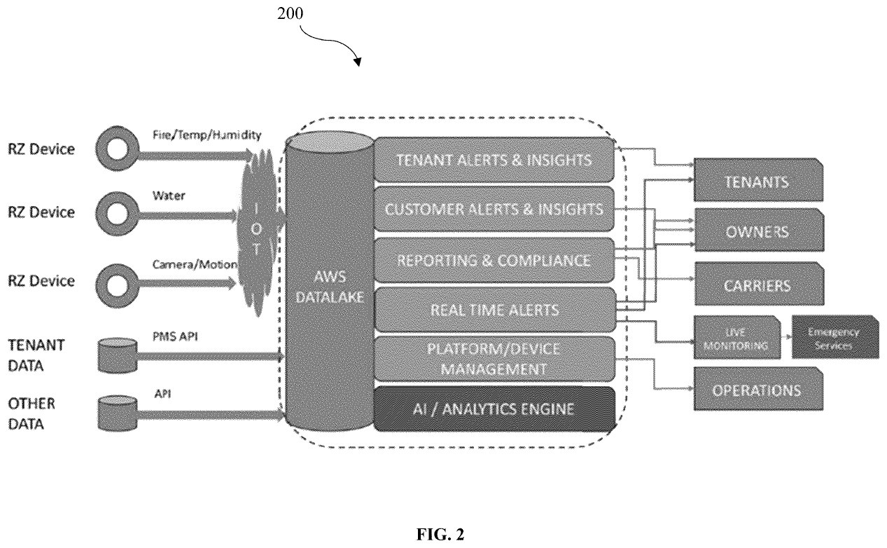

FIG. 1 shows a block diagram illustrating an exemplary system 100 according to one or more of the embodiments disclosed herein. The compute device 101 includes a processor 102, a memory 103, and I/O interface(s) 107 that communicate with each other, and with other components, via a bus 104. The bus 104 can include any of several types of bus structures including, but not limited to, a memory bus, a memory controller, a peripheral bus, a local bus, and any combinations thereof, using any of a variety of bus architectures. The compute device 101 can be or include, for example, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. The compute device 101 can also include multiple compute devices that can be used to implement a specially configured set of instructions for causing one or more of the compute devices to perform any one or more of the aspects and/or methodologies described herein.

The compute device 101 can include a network interface 106. The network interface 106, can be utilized for connecting the compute device 101 to one or more of a variety of networks (e.g., network 140) and one or more remote devices connected thereto (e.g., sensor(s) 131 at a first dwelling, sensor(s) 133 at a second dwelling, and sensor(s) 135 at a third dwelling). In other words, various devices, including compute device 101, can communicate with other devices, including sensors 131,133,135 via the network 140. The network 140 can include, for example, private network, a Virtual Private Network (VPN), a Multiprotocol Label Switching (MPLS) circuit, the Internet, an intranet, a local area network (LAN), a wide area network (WAN), a metropolitan area network (MAN), a worldwide interoperability for microwave access network (WiMAX®), an optical fiber (or fiber optic)-based network, a Bluetooth® network, a virtual network, and/or any combination thereof. In some instances, the network 140 can be a wireless network such as, for example, a Wi-Fi or wireless local area network (“WLAN”), a wireless wide area network (“WWAN”), and/or a cellular network. In other instances, the network 140 can be a wired network such as, for example, an Ethernet network, a digital subscription line (“DSL”) network, a broadband network, and/or a fiber-optic network. In some instances, the compute device 101 can use Application Programming Interfaces (APIs) and/or data interchange formats (e.g., Representational State Transfer (REST), JavaScript Object Notation (JSON), Extensible Markup Language (XML), Simple Object Access Protocol (SOAP), and/or Java Message Service (JMS)). The communications sent via the network 140 can be encrypted or unencrypted. In some instances, the network 140 can include multiple networks or subnetworks operatively coupled to one another by, for example, network bridges, routers, switches, gateways and/or the like.

The processor 102 can be or include, for example, a hardware based integrated circuit (IC), or any other suitable processing device configured to run and/or execute a set of instructions or code. For example, the processor 102 can be a general-purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC) and/or the like. In some implementations, the processor 102 can be configured to run any of the methods and/or portions of methods discussed herein.

The memory 103 can be or include, for example, a random-access memory (RAM), a memory buffer, a hard drive, a read-only memory (ROM), an erasable programmable read-only memory (EPROM), and/or the like. In some instances, the memory 103 can store, for example, one or more software programs and/or code that can include instructions to cause the processor 102 to perform one or more processes, functions, and/or the like. In some implementations, the memory 103 stores a machine-learning model 120 configured to generate one or more of risk projection 121, ratings 124, notifications 126, and/or alerts 128. In some implementations, the memory 103 includes software configured to generate a dashboard 122. In some implementations, the memory 103 can include extendable storage units that can be added and used incrementally. In some implementations, the memory 103 can be a portable memory (e.g., a flash drive, a portable hard disk, and/or the like) that can be operatively coupled to the processor 102. In some instances, the memory 103 can be operatively coupled with another device, such as, for example, a database device 105. In such implementations, the database 105 can serve as additional storage for data such as, but not limited to, sensor data 110, user data 112, external data 114, and/or training data 116. The memory 103 can include various components (e.g., machine-readable media) including, but not limited to, a random-access memory component, a read only component, and any combinations thereof.

In one example, a basic input/output system (BIOS), including basic routines that help to transfer information between components within the compute device 101 can be stored in memory 103. The memory 103 can further include any number of program modules including, for example, an operating system, one or more application programs, other program modules, program data, and any combinations thereof.

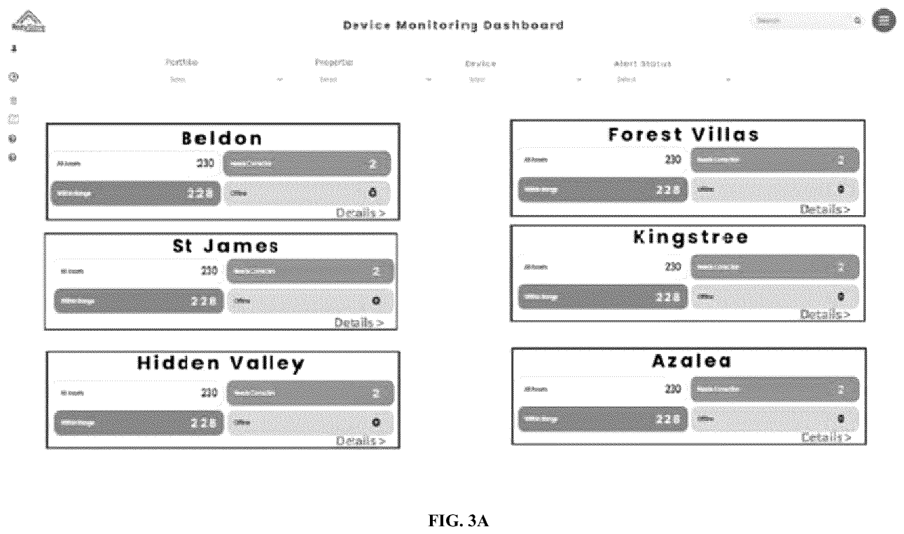

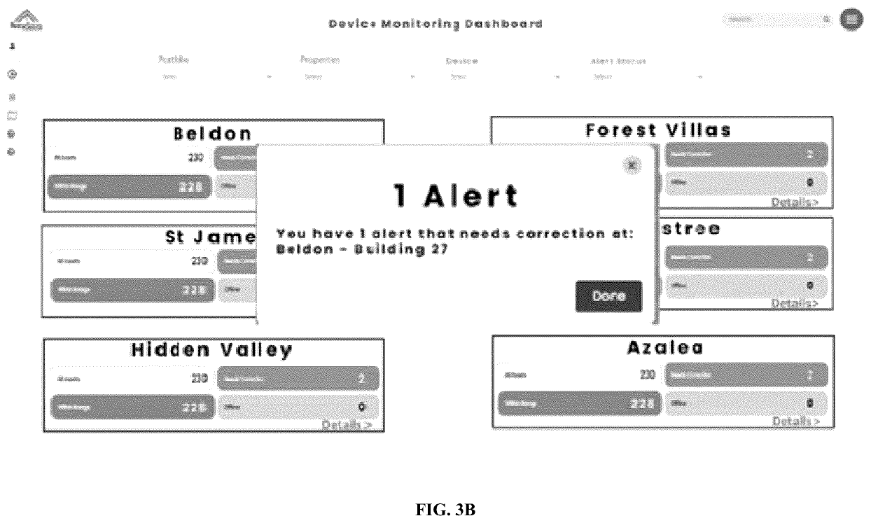

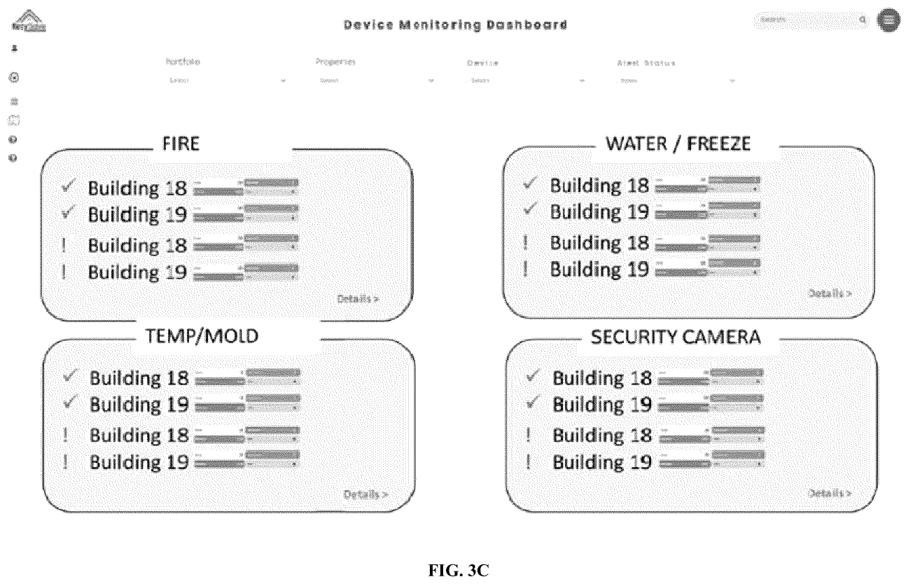

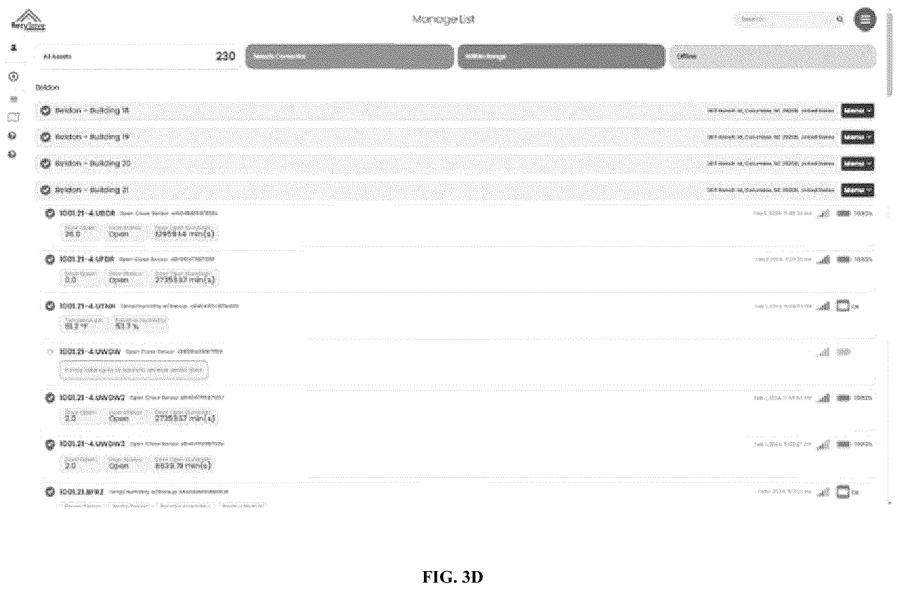

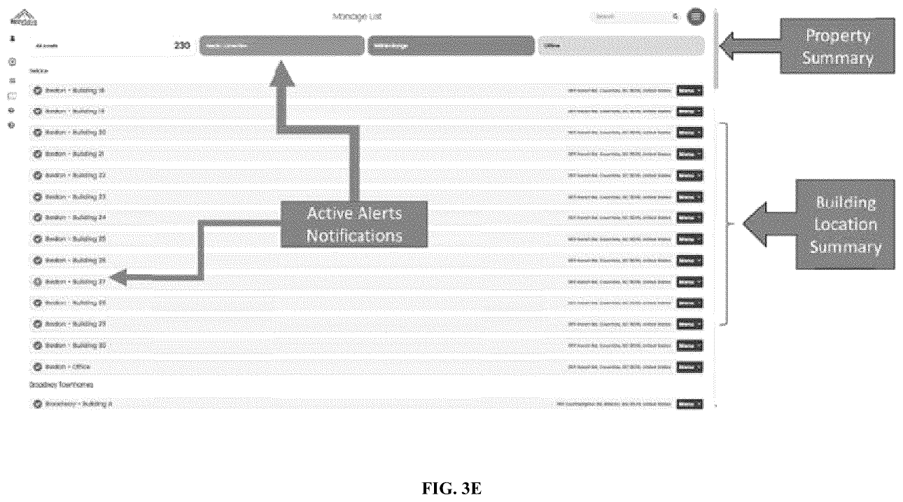

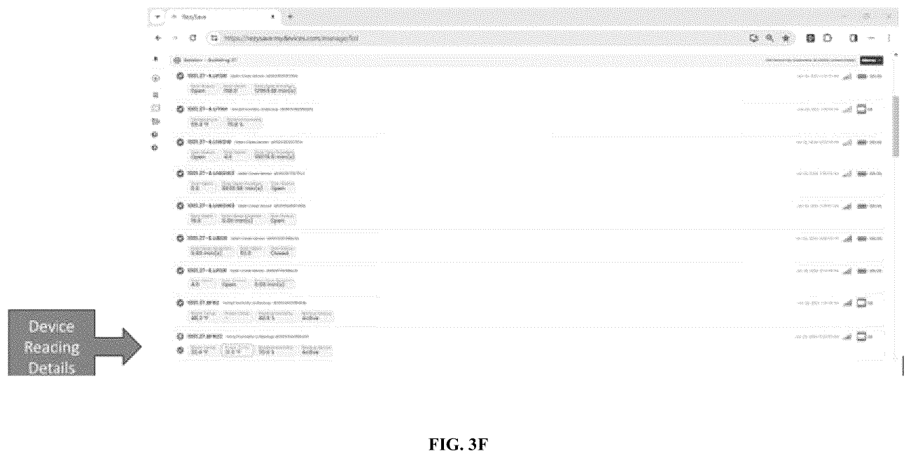

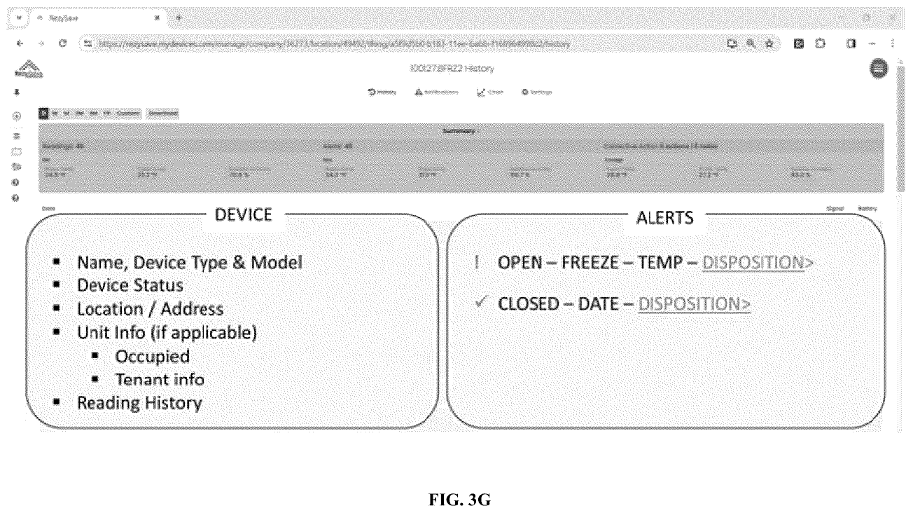

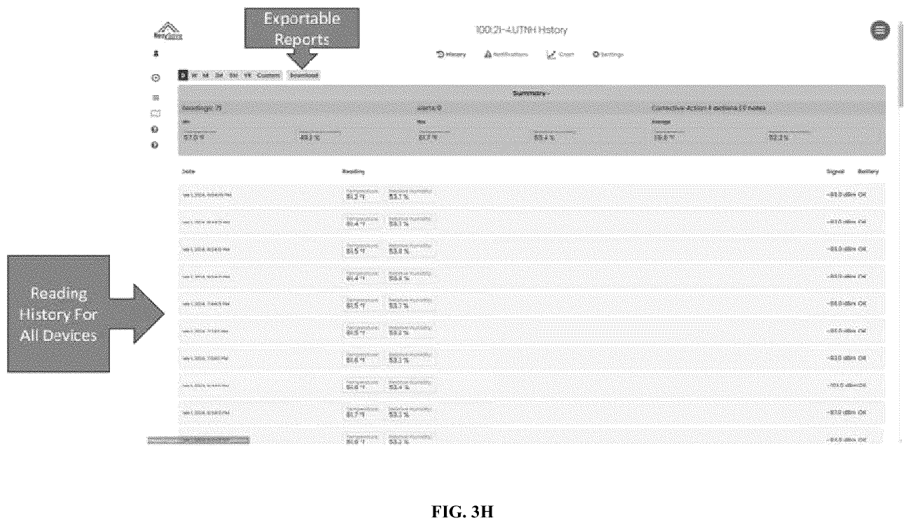

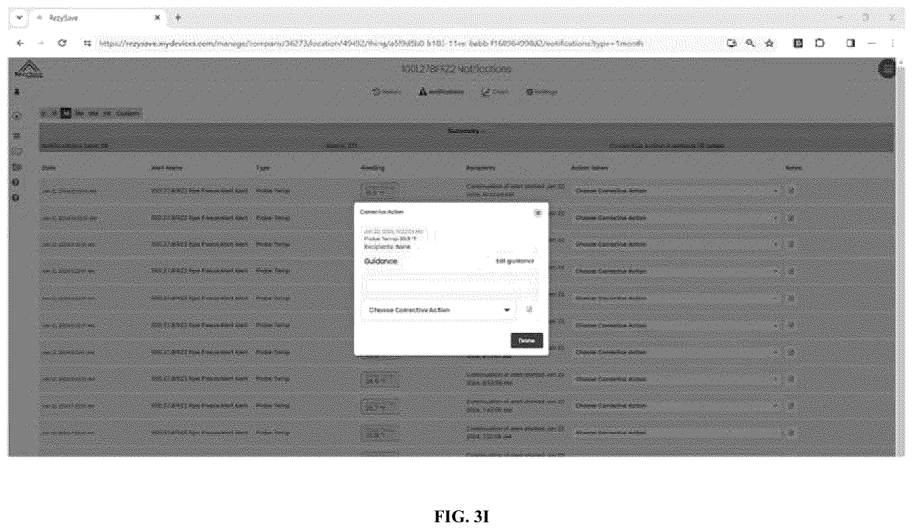

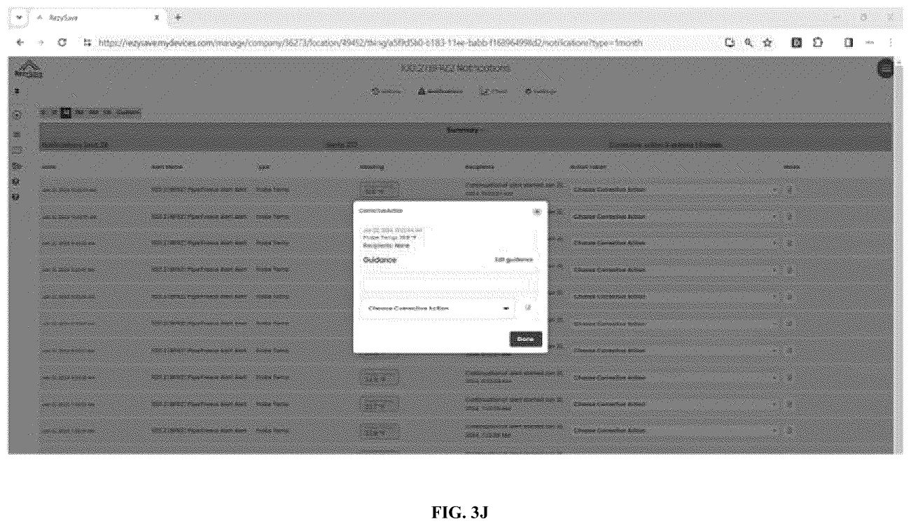

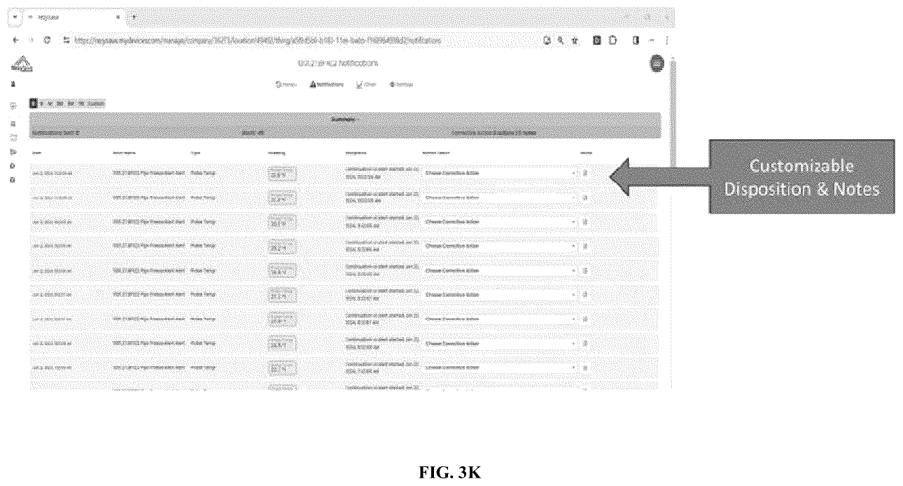

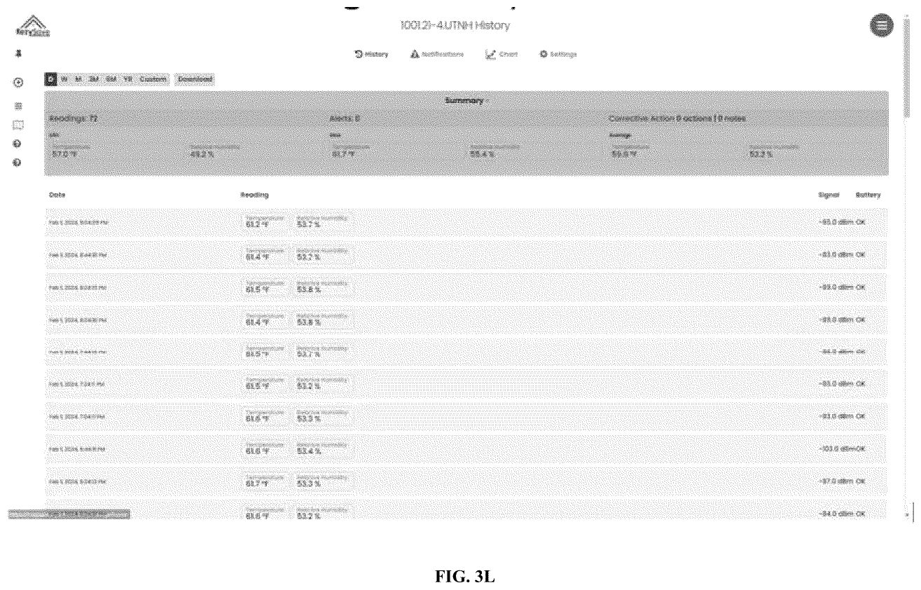

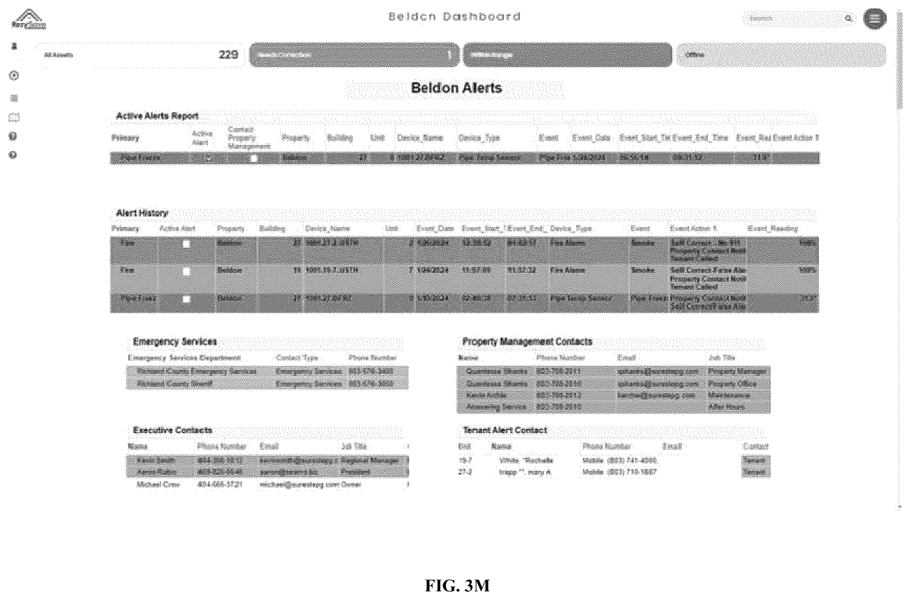

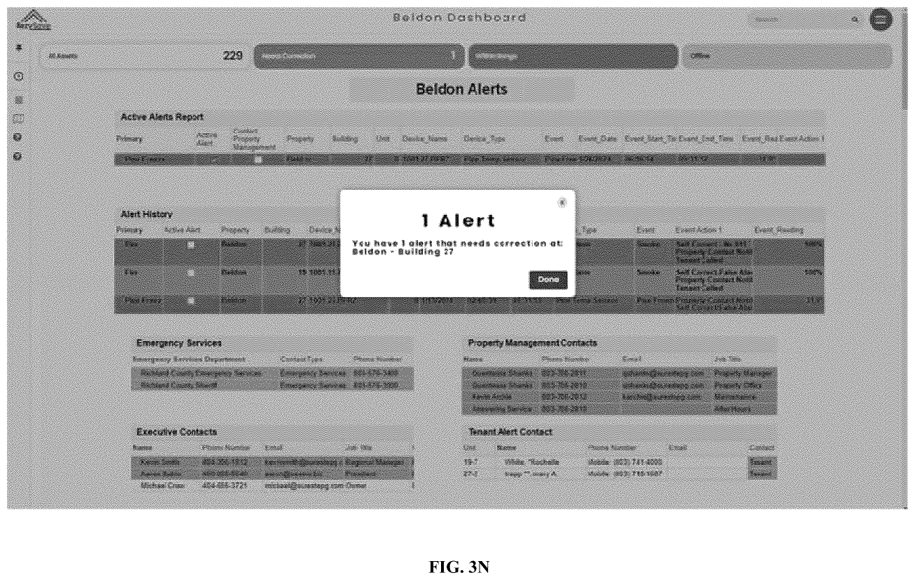

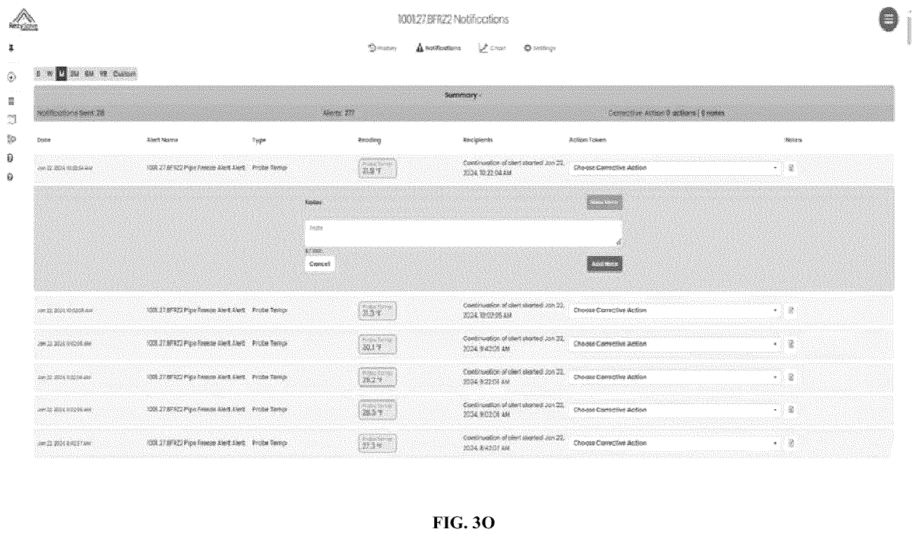

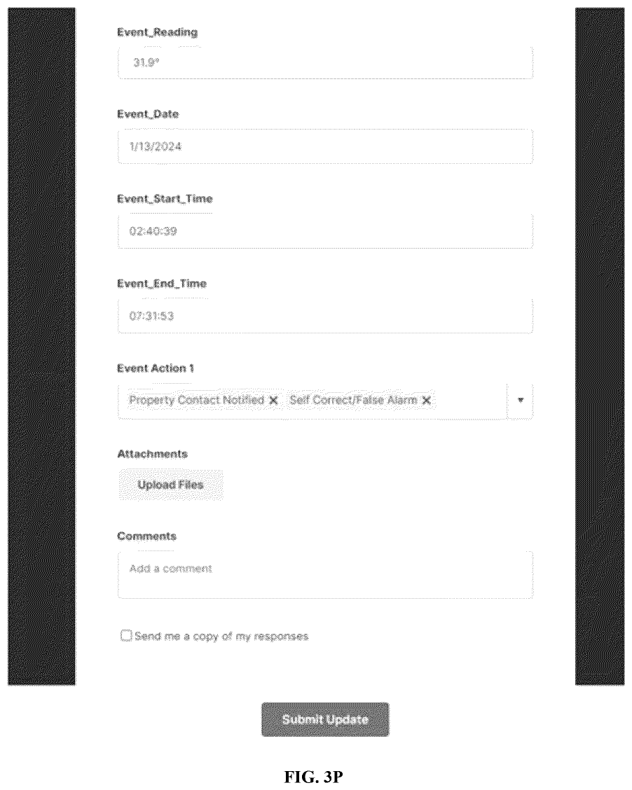

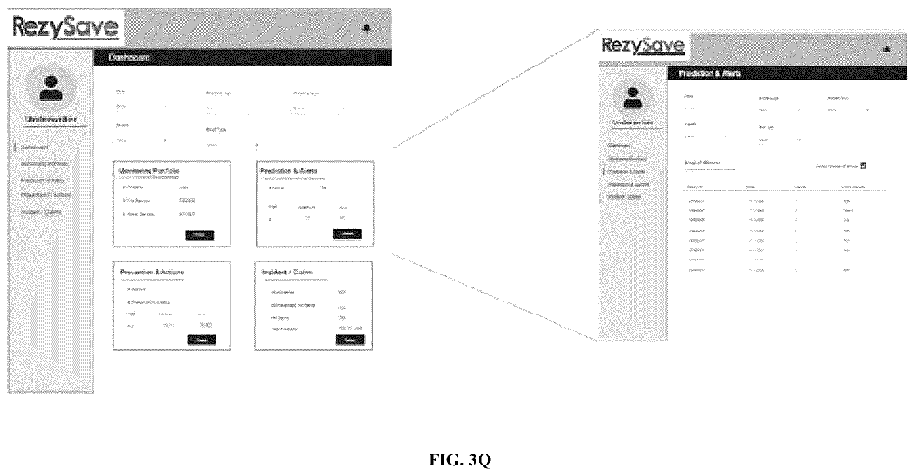

FIG. 2 shows a schematic illustration operation 200 of the system according to one or more of the embodiments disclosed herein. FIGS. 3A-Q show screenshots of various aspects of the monitoring software and user interface. As shown therein, multiple dwellings at various properties are displayed in a central dashboard, enabling efficient monitoring of all relevant dwellings.

### EQUIVALENTS

Although preferred embodiments of the invention have been described using specific terms, such description is for illustrative purposes only, and it is to be understood that changes and variations may be made without departing from the spirit or scope of the following claims.

What is claimed is:

1. A system comprising:
a server;
a plurality of sensors located at one or more dwellings, the plurality of sensors configured to generate sensor data and communicate the sensor data to the server; and
monitoring software configured to run on the server;
wherein the monitoring software is configured to process the sensor data and generate at least one user interface;
wherein the at least one user interface is accessible through a remote compute device; and
wherein the at least one user interface is configured to display at least one of the sensor data and one or more alerts.

2. The system of claim 1, further comprising:
a machine-learning model configured to run on the server;
wherein the machine-learning model is configured to automatically generate the one or more alerts based upon the sensor data.

3. The system of claim 2, wherein the machine-learning model is an unsupervised machine-learning model, a supervised machine-learning model, a deep learning model, or a convolutional neural network (CNN).

4. The system of claim 2, wherein the machine-learning model generates the one or more alerts in response to the sensor data deviating from a set of threshold values.

5. The system of claim 4, wherein the machine-learning model is configured to automatically adjust the set of threshold values.

6. The system of claim 4, wherein:
the system further comprises a database; and
the server is further configured to store the sensor data and the set of predetermined threshold values in the database.

7. The system of claim 4, wherein the set of threshold values includes a set of combination threshold values, the set of combination threshold values being determined from threshold values for two or more individual sensor types from the plurality of sensors.

8. The system of claim 2, wherein the one or more alerts include a security alert, a fire alert, a mold alert, an occupancy alert, a carbon monoxide alert, a water leak alert, an electrical alert, a sensor status alert, or a combination thereof.

9. The system of claim 1, wherein the plurality of sensors includes at least one of a water flow sensor, a water leak sensor, a temperature sensor, a motion sensor, a license plate recognition sensor, a smoke detector, a carbon monoxide sensor, a thermal imaging sensor, a barometric sensor, a power line sensor, a current sensor, and combinations thereof.

10. The system of claim 9, wherein the plurality of sensors are connected through the internet of things (IoT).

11. The system of claim 1, wherein the sensor data comprises multimodal telemetry data.

12. The system of claim 1, wherein the at least one user interface comprises one or more of a property owner interface, a property manager interface, and a tenant interface.

13. The system of claim 12, wherein:
the property owner interface displays the sensor data and the one or more alerts for at least one property owned by a property owner, the at least one property including at least one of the one or more dwellings;
the property manager interface displays the sensor data and the one or more alerts for at least one of the one or more dwellings managed by a property manager; and
the tenant interface displays the sensor data and the one or more alerts for at least one of the one or more dwellings assigned to a tenant.

14. The system of claim 13, wherein the monitoring software provides automatic communication between two or more of the property owner, the property manager, and the tenant.

15. The system of claim 13, wherein the system is configured to automatically update the status of the one or more alerts based upon updated sensor data, input from the tenant, input from the property manager, input from the property owner, communication with the authorities, or a combination thereof.

16. The system of claim 13, wherein:
the remote compute device for at least one of the user interfaces comprises a mobile device; and
at least one of the user interfaces comprises a mobile device application.

17. The system of claim 1, wherein the system is further configured to generate a behavior score for a tenant based upon the sensor data from one or more sensors of the plurality of sensors that are specific to the tenant.

18. The system of claim 17, wherein the system is further configured to dynamically allocate a reward for the tenant based on the behavior score.

19. A method of monitoring a multi-unit dwelling, the method comprising:
providing the system according to claim 2;
receiving, at the server, the sensor data from the plurality of sensors;
executing the machine-learning model on the sensor data, the machine-learning model generating the one or more alerts;
generating the at least one user interface accessible through the remote compute device.

20. The method of claim 19, further comprising automatically sending a signal to at least one of emergency services, a property owner, a property manager, and a tenant for at least one of the one or more alerts.

21. The method of claim 19, further comprising generating a behavior score for a tenant based upon the sensor data from one or more sensors of the plurality of sensors that are specific to the tenant.

22. The method of claim 21, further comprising dynamically allocating a reward for the tenant based on the behavior score.

23. The method of claim 21, wherein the sensors specific to the tenant include the sensors associated with a tenant dwelling assigned to the tenant, the sensor data associated with a vehicle of the tenant, the sensor data relating to location of the tenant, or a combination thereof.

24. The method of claim 19, further comprising training the machine-learning model, the training including:
providing a training set including at least one of tenant data, property data, and significant events related thereto; and
training the machine-learning model to generate the one or more alerts with the training set.

25. The method of claim 24, wherein the training set includes at least one of tenant data and property compared to significant events related thereto.

26. A non-transitory, processor-readable medium storing instructions that, when executed by a processor, cause the processor to implement the method according to claim 19.
